(19) United States
(12) Patent Application Publication
(10) Pub. No.: US 2023/0359948 A1
(43) Pub. Date: Nov. 9, 2023

(54) METHOD AND APPARATUS FOR DETERMINING QUEUING SOLUTION, AND ELECTRONIC DEVICE AND COMPUTER-READABLE MEDIUM

(71) Applicant: BOE TECHNOLOGY GROUP CO., LTD., Beijing (CN)

(72) Inventor: Zhenzhong ZHANG, Beijing (CN)

(21) Appl. No.: 18/245,172

(22) PCT Filed: Aug. 20, 2021
(86) PCT No.: PCT/CN2021/113674

§ 371 Date: Mar. 14, 2023

(30) Foreign Application Priority Data
Sep. 15, 2020 (CN) 202010969781.0

(51) Int. Cl. G06Q 10/04; G06Q 10/109; G07C 11/00

(52) U.S. Cl. CPC G06Q 10/04; G06Q 10/109; G07C 11/00; G07C 2011/04

(57) ABSTRACT

Provided is a method and device for determining a queuing scheme. The method includes: obtaining candidate queuing schemes by using each to-be-executed item as a first-order item, using the to-be-executed item other than the first-order item as other items; for each candidate queuing scheme, obtaining a completion time for the first-order item according to a number of current queueing people and a unit execution time for the first-order item; determining a number of increased queuing people for each of the other items according to the completion time for the first-order item; obtaining the completion time for all the other items according to the number of the current queuing people, the number of the increased queuing people and the unit execution time for each of the other items; calculating a total time for completion of all the to-be-executed items in each candidate queuing scheme, and determining a target queuing scheme.

### CROSS-REFERENCE TO RELATED APPLICATIONS

The present application claims the priority to Chinese Patent Application No. 202010969781.0, titled “Method and Device for Determining Queuing Scheme, Electronic Device and Computer-readable Medium” filed on Sep. 15, 2020, the entire contents thereof are incorporated herein by reference.

### TECHNICAL FIELD

The present disclosure relates to the technical field of data processing, and particularly, to a method and device for determining a queuing scheme, an electronic device and a computer-readable medium.

### BACKGROUND

In everyday life, when people are faced with situations where they need to queue, they usually choose a queue with a smaller number of people based on the current number of people in each queue.

However, in situation where there are many items to be queued and a large number of people, it is difficult to estimate an order in which the user can complete all items with the minimum waiting time so as to have an improved queuing efficiency and thus save time, as different queues have different numbers of people and different queuing progresses.

Accordingly, there is an urgent need in the field for a method for determining a queuing scheme that can effectively improve queuing efficiency.

It should be noted that the information disclosed in the background section above is only to enhance the understanding of the present disclosure and may therefore include information that does not constitute the prior art known to those skilled in the art.

### SUMMARY

The present disclosure provides a method and device for determining a queuing scheme, an electronic device and a computer-readable medium.

A first aspect of the present disclosure provides a method for determining a queuing scheme, including:

obtaining a plurality of candidate queuing schemes by using each of to-be-executed items in turn as a first-order item and using the to-be-executed item other than the first-order item as other items;

for each of the candidate queuing schemes, obtaining a completion time for the first-order item according to a number of current queueing people for the first-order item and a unit execution time for the first-order item;

determining a number of increased queuing people for each of the other items according to the completion time for the first-order item;

obtaining the completion time for all the other items according to the number of the current queuing people, the number of the increased queuing people and a corresponding unit execution time for each of the other items; and

calculating a total time for completion of all the to-be-executed items in each of the candidate queuing schemes, and determining a target queuing scheme according to the total time.

In an exemplary embodiment of the present disclosure, obtaining the completion time for all the other items according to the number of the current queuing people, the number of the increased queuing people and the corresponding unit execution time for each of the other items includes:

obtaining the completion time for all the other items by performing iteration according to a number of iterations and according to the number of the current queuing people, the number of the increased queuing people and the corresponding unit execution time for each of the other items.

In an exemplary embodiment of the present disclosure, obtaining the completion time for all the other items by performing iteration according to the number of the iterations and according to the number of the current queuing people, the number of the increased queuing people and the corresponding unit execution time for each of the other items includes:

determining the number of the iterations according to a total number of the to-be-executed items;

a step of determining a next item, including, for each of the candidate queuing schemes, determining a current-order item and using an unordered item of the other items in turn as a next-order item;

a step of calculating the completion time, including obtaining the completion time for the next-order item according to the number of the current queuing people, the number of the increased queuing people and the corresponding unit execution time for the next-order item;

a step of determining a number of increased people, including determining, according to the completion time of a current ordered item, the number of the increased queuing people for each of the unordered item other than the current ordered item in the other items; and

determining the completion time of each order item in turn by repeating, according to the number of the iterations, the step of determining the next item, the step of calculating the completion time and the step of determining the number of the increased people, and obtaining the completion time for all the other items according to the completion time of each order item.

In an exemplary embodiment of the present disclosure, obtaining the completion time for all the other items by performing iteration according to the number of the iterations and according to the number of the current queuing people, the number of the increased queuing people and the corresponding unit execution time for each of the other items includes:

obtaining a predetermined number of iterations;

a step of determining a next item, including, for each of the candidate queuing schemes, determining a current-order item and using an unordered item of the other items in turn as a next-order item;

a step of calculating the completion time, including obtaining the completion time for the next-order item according to the number of the current queuing people, the number of the increased queuing people and the corresponding unit execution time for the next-order item;

a step of determining a number of increased people, including determining, according to the completion time of a current ordered item, the number of the increased queuing people for each of the unordered item other than the current ordered item in the other items;

determining the completion time for predetermined-order items corresponding to the predetermined number of the iterations in all the other items in turn by repeating, according to the predetermined number of the iterations, the step of determining the next item, the step of calculating the completion time, and the step of determining the number of the increased people; and

after the iteration, obtaining the completion time for all the other items according to the completion time for the predetermined-order items.

In an exemplary embodiment of the present disclosure, obtaining the completion time for the first-order item according to the number of the current queueing people for the first-order item and the unit execution time for the first-order item includes:

obtaining a movement distance between the first-order item and the next-order item to the first-order item;

obtaining movement speed data of a user, and obtaining a movement time of the user according to a ratio between the movement distance and the movement speed data; and

obtaining the completion time for the first-order item according to the movement time of the user, the number of the current queueing people for the first-order item and the unit execution time for the first-order item.

In an exemplary embodiment of the present disclosure, obtaining the completion time for the next-order item according to the number of the current queuing people, the number of the increased queuing people and the corresponding unit execution time for the next-order item includes:

obtaining a total number of people executing the next-order item according to the number of the current queuing people and the number of the increased queuing people for the next-order item;

obtaining a waiting time for the next-order item according to the total number of people executing the next-order item and the unit execution time for the next-order item; and

obtaining the completion time for the next-order item according to the waiting time for the next-order item, the completion time for the current-order item and the unit execution time for the next-order item.

In an exemplary embodiment of the present disclosure, obtaining the completion time for the next-order item according to the waiting time for the next-order item, the completion time for the current-order item and the unit execution time for the next-order item includes:

obtaining the completion time for the next-order item according to the waiting time for the next-order item, the completion time for the current-order item and the unit execution time for the next-order item when a sum of the waiting time for the next-order item and the unit execution time for the next-order item is greater than or equal to the completion time for the current first-order item; and

taking the unit execution time for the next-order item as the completion time for the next-order item when the sum of the waiting time for the next-order item and the unit execution time for the next-order item is smaller than the completion time for the current-order item.

In an exemplary embodiment of the present disclosure, obtaining the completion time for the next-order item according to the waiting time for the next-order item, the completion time for the current-order item and the unit execution time for the next-order item includes:

determining, from the unordered item, the order item after the next-order item, and obtaining a movement distance between the next-order item and the order item after the next-order item;

obtaining movement speed data of a user, and obtaining a movement time of the user according to a ratio between the movement distance and the movement speed data; and

obtaining the completion time for the next-order item according to the movement time of the user, the waiting time for the next-order item, the completion time for the current-order item and the unit execution time for the next-order item.

In an exemplary embodiment of the present disclosure, determining the number of the increased queuing people for each of the other items according to the completion time for the first-order item includes:

obtaining historical data of increased users within a plurality of unit time periods, and determining a number of the increased users within the completion time for the first-order item according to the historical data; and

determining the number of the increased queuing people for each of the other items within the completion time for the first-order item according to the number of the increased users within the completion time for the first-order item.

In an exemplary embodiment of the present disclosure, obtaining the historical data of the increased users within the plurality of the unit time periods includes:

obtaining a collection period for the historical data; and

obtaining the historical data of the increased users within the unit time period of corresponding time points in each collection period according to the collection period for the historical data.

In an exemplary embodiment of the present disclosure, obtaining the historical data of the increased users within the plurality of unit time periods includes:

randomly obtaining the historical data of the increased users within the plurality of unit time periods.

In an exemplary embodiment of the present disclosure, the historical data of the increased users within the plurality of unit time periods obeys a first probability distribution, and determining the number of the increased users within the completion time for the first-order item according to the historical data includes:

determining a distribution parameter in the first probability distribution according to the historical data, and determining a number of the unit time periods within the completion time for the first-order item; and

determining the number of the increased users within the completion time for the first-order item according to the distribution parameter and the number of the unit time periods within the completion time for the first-order item.

In an exemplary embodiment of the present disclosure, determining the number of the increased users within the completion time for the first-order item according to the distribution parameter and the number of the unit time periods within the completion time for the first-order item includes:

determining the number of the increased users within the completion time for the first-order item based on the first probability distribution according to the distribution parameter and the number of the unit time periods, when the unit time periods within the completion time for the first-order item are all integral unit time periods;

determining a second probability distribution obeyed by the incomplete unit time period according to the first probability distribution obeyed by the integral unit time period, when the unit time periods within the completion time for the first-order item includes the integral unit time period and an incomplete unit time period;

determining a first number of the increased users within the integral unit time period based on the first probability distribution according to the distribution parameter and the number of the integral unit time periods;

determining a second number of the increased users within the incomplete unit time period based on the second probability distribution according to the distribution parameter; and

determining the number of the increased users within the completion time for the first-order item according to the first number of the increased users and the second number of the increased users.

In an exemplary embodiment of the present disclosure, determining the first number of the increased users within the integral unit time period based on the first probability distribution according to the distribution parameter and the number of the integral unit time periods includes:

determining an expected value of the first number of the increased users based on first probability distribution according to the distribution parameter and the number of the integral unit time periods; and

using the expected value of the first number of the increased users as the first number of the increased users for the integral unit time period within the completion time for the first-order item.

In an exemplary embodiment of the present disclosure, determining the second number of the increased users within the incomplete unit time period based on the second probability distribution according to the distribution parameter includes:

determining an expected value of the second number of the increased users based on the second probability distribution according to the distribution parameter; and

using the expected value of the second number of the increased users as the second number of the increased users for the incomplete unit time period within the completion time for the first-order item.

In an exemplary embodiment of the present disclosure, determining the number of the increased queuing people for each of the other items within the completion time for the first-order item according to the number of the increased users within the completion time for the first-order item includes:

obtaining a historical number of the increased queuing people for each of the other items within the plurality of unit time periods according to the historical data of the increased users, wherein the historical number of the increased queuing people obeys a third probability distribution;

determining a distribution parameter in the third probability distribution according to the historical number of the increased queuing people for each of the other items within the plurality of unit time periods; and

determining the number of the increased queuing people for each of the other items within the completion time for the first-order item according to the number of the increased users within the completion time for the first-order item and the distribution parameter in the third probability distribution.

In an exemplary embodiment of the present disclosure, determining the number of the increased queuing people for each of the other items within the completion time for the first-order item according to the number of the increased users within the completion time for the first-order item and the distribution parameter in the third probability distribution includes:

determining an expected value of the number of the increased queuing people for each of the other items according to the number of the increased users within the completion time for the first-order item and the distribution parameter in the third probability distribution; and

using the expected value of the number of the increased queuing people as the number of the increased queuing people for each of the other items within the completion time for the first-order item.

In an exemplary embodiment of the present disclosure, determining the target queuing scheme according to the total time includes:

determining the candidate queuing scheme with a least total time as the target queuing scheme.

A second aspect of the present disclosure provides a device for determining a queuing scheme, including:

a candidate queuing scheme-determining module, configured to obtain a plurality of candidate queuing schemes by using each of to-be-executed items in turn as a first-order item and using the to-be-executed item other than the first-order item as other items;

a first item time-determining module, configured to, for each of the candidate queuing schemes, obtain a completion time for the first-order item according to a number of current queueing people for the first-order item and a unit execution time for the first-order item;

a number of increased queuing people-determining module, configured to determine a number of increased queuing people for each of the other items according to the completion time for the first-order item;

an other item time-determining module, configured to obtain the completion time for all the other items according to the number of the current queuing people, the number of the increased queuing people and a corresponding unit execution time for each of the other items; and

a target queuing scheme-determining module, configured to calculate a total time for completion of all the to-be-executed items in each of the candidate queuing schemes, and determine a target queuing scheme according to the total time.

A third aspect of the present disclosure provides an electronic device, including:

a processor; and a memory having an executable instruction by the processor, the processor is configured to perform any one of the above methods for determining the queuing scheme by executing the executable instruction.

A fourth aspect of the present disclosure provides a computer readable medium having a computer program stored thereon that, when being executed by a processor, implements any one of the above methods for determining the queuing scheme.

It is to be understood that the foregoing general description and the following detailed description are exemplary and explanatory only and are not intended to limit the present disclosure.

### BRIEF DESCRIPTION OF THE DRAWINGS

The accompanying drawings herein, which are incorporated in and constitute a part of this specification, illustrate embodiments consistent with the present disclosure, and together with the description, serve to explain the principle of the embodiments of the present disclosure. It will be apparent that the accompanying drawings in the following description are only some embodiments of the present disclosure, and that other accompanying drawings may be obtained by those skilled in the art in accordance with these accompanying drawings without creative work.

FIG. 1 schematically illustrates a schematic flow diagram of a method for determining a queuing scheme according to an exemplary embodiment of the present disclosure.

FIG. 2 schematically illustrates a schematic diagram of a main flow of a physical examination center according to a specific embodiment of the present disclosure.

FIG. 3 schematically illustrates a schematic flow diagram for determining the number of increased queuing people for each of the other items according to an exemplary embodiment of the present disclosure.

FIG. 4 illustrates a schematic flow diagram for determining the number of increased users based on historical data according to an exemplary embodiment of the present disclosure.

FIG. 5 illustrates a schematic flow diagram for determining the number of increased users based on a distribution parameter according to an exemplary embodiment of the present disclosure.

FIG. 6 illustrates a schematic flow diagram for determining the number of increased queuing people for each item based on the number of increased users according to an exemplary embodiment of the present disclosure.

FIG. 7 illustrates a schematic flow diagram for obtaining completion times for all other items by iteration according to an exemplary embodiment of the present disclosure.

FIG. 8 illustrates a schematic flow diagram for obtaining a completion time for a next-order item according to an exemplary embodiment of the present disclosure.

FIG. 9 illustrates a schematic flow diagram for obtaining a completion time for a next-order item based on a travelled distance according to an exemplary embodiment of the present disclosure.

FIG. 10 schematically illustrates a schematic flow diagram of an iterative method according to a specific embodiment of the present disclosure.

FIG. 11 schematically illustrates another flow schematic diagram for obtaining completion times for all other items by iteration according to an exemplary embodiment of the present disclosure.

FIG. 12 schematically illustrates a schematic diagram of a user queuing situation according to a specific embodiment of the present disclosure.

FIG. 13 schematically illustrates a schematic diagram of an output of a queuing system according to a specific embodiment of the present disclosure.

FIG. 14 illustrates a block diagram of a device for determining a queuing scheme according to an exemplary embodiment of the present disclosure.

FIG. 15 illustrates a schematic structure diagram of a computer system suitable for implementing an electronic device according to an exemplary embodiment of the present disclosure.

### DETAILED DESCRIPTION

Exemplary embodiments will now be described more fully with reference to the accompanying drawings. However, the exemplary embodiments may be implemented in various forms and should not be construed as being limited to the examples set forth herein. Rather, these embodiments are provided so that the present disclosure is more comprehensive and complete and the concept of the exemplary embodiments is conveyed to those skilled in the art in a comprehensive manner. The features, structures or characteristics described may be combined in any suitable manner in one or more embodiments. In the following description, many specific details are provided so as to give a full understanding of the embodiments of the present disclosure. However, those skilled in the art will appreciate that it is possible to practice the technical solution of the present disclosure without one or more of the specific details described, or by employing other methods, components, devices, steps and the like. In other instances, the well-known technical solutions are not shown or described in detail to avoid obscuring aspects of the present disclosure.

In addition, the accompanying drawings are only schematic illustrations of the present disclosure and are not necessarily drawn to scale. Same reference numerals in the drawings indicate same or similar parts, and thus the description thereof will be not repeated. Some of the block diagrams shown in the accompanying drawings are functional entities and do not necessarily have to correspond to physically or logically separate entities. These functional entities may be implemented in software form, or in one or more hardware modules or integrated circuits, or in different networks and/or processor devices and/or microcontroller devices.

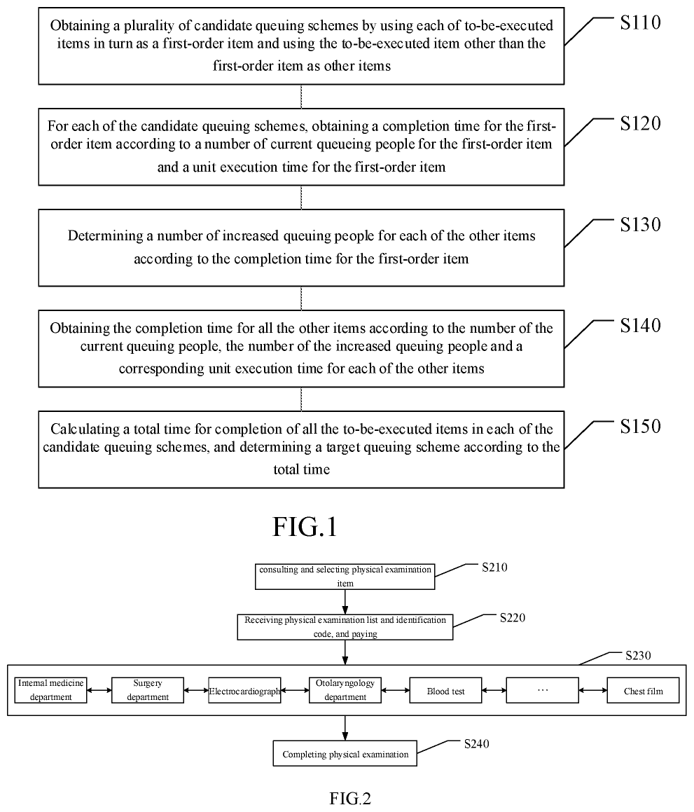

An exemplary embodiment of the present disclosure first provides a method for determining a queuing scheme. Referring to FIG. 1, the above method for determining the queuing scheme may include:

step S110, obtaining a plurality of candidate queuing schemes by using each of to-be-executed items in turn as a first-order item and using the to-be-executed item other than the first-order item as other items;

step S120, for each of the candidate queuing schemes, obtaining a completion time for the first-order item according to a number of current queueing people for the first-order item and a unit execution time for the first-order item;

step S130, determining a number of increased queuing people for each of the other items according to the completion time for the first-order item;

step S140, obtaining the completion time for all the other items according to the number of the current queuing people, the number of the increased queuing people and a corresponding unit execution time for each of the other items; and

step S150, calculating a total time for completion of all the to-be-executed items in each of the candidate queuing schemes, and determining a target queuing scheme according to the total time.

The method for determining the queuing scheme in the exemplary embodiment of the present disclosure may be used for planning a queuing scheme in a scenario having a plurality of people and a plurality of items. For example, it may be used to determine an optimal queuing scheme for a physical examination item, or determine an optimal queuing scheme for an amusement park item and the like. In the following description of the exemplary embodiment of the present disclosure, only the method for determining the queuing scheme for the physical examination items will be explained as an example, which may be similarly applied to other scenarios.

Generally, the main process of a physical examination center is as shown in FIG. 2.

In step S210, a user consults and selects a physical examination item.

In step S220, the user receives a physical examination list and an identification code and pays for it.

In step S230, the user has a physical examination according to the physical examination item chosen.

In general, the physical examination items in step S230 are independent of each other and have no defined order.

In step S240, the physical examination is completed.

It is assumed that the user has selected N physical examination items, i.e., a1, a2, . . . , aN, each of the physical examination items takes time ti (i=1, 2, . . . , N) to be completed for a single person, and each item currently has p1, p2, . . . , pN persons in the queue. Intuitively, the user would choose the item with the shortest current queuing time, i.e., the one with the queuing time of min(ti*pi)(i=1, 2, . . . , N).

However, the above method only statically considers the current queuing situation and does not take into account that new users will join the queue during queuing. For example, it is assumed that there are only two physical examination items x and y, a single person respectively needs 10 and 15 minutes to complete the physical examination items x and y, and there is one person queuing for item x and no person queuing for item y. If a user selects item y first, the user will only need 15 minutes to complete item y as the waiting time for item y is 0 at this point. It is assumed that 3 users are increased during this 15-minute period and all the 3 users select the physical examination item x, there will be 2 persons queuing for item x when the user completes item y, i.e., the user will have to wait at least 20 minutes. If the user selects item x first, he/she will only need to wait 10 minutes and then spend another 10 minutes completing item x. As the new/increased users have all selected item x, the user can start item y straight away without having to wait again. In this case, the user waits for only 10 minutes and the waiting time is less than that in the first case.

In the method for determining the queuing scheme according to the exemplary embodiment of the present disclosure, it estimates, in each of the candidate queuing schemes, the number of increased queuing people for each of the other items within the time of the user completing a certain item, then estimates a total time for the user completing all the items in each of the candidate queuing schemes according to the number of the current queuing people and the number of the increased queuing people for each item, and finally obtains the optimal queuing scheme according to the total time. The method for determining the queuing scheme according to the exemplary embodiment of the present disclosure may plan an optimal queuing scheme according to the queuing situation of the newly-increased users in each item, so as to minimize the queuing and waiting time of the user for completing all items, thereby improving the queuing efficiency of the user and saving the time of the user.

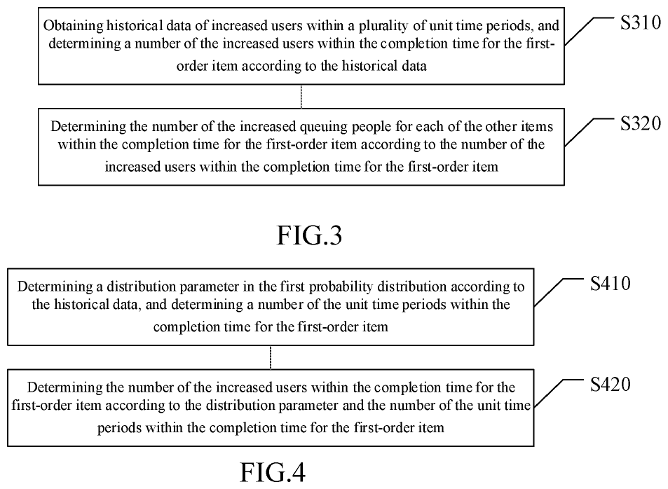

In the following, the steps in FIG. 1 according to the exemplary embodiment of the present disclosure are described in more detail in connection with FIGS. 3 to 11.

In step S110, it obtains a plurality of candidate queuing schemes by using each of to-be-executed items in turn as a first-order item and using the to-be-executed item other than the first-order item as other items.

In an exemplary embodiment, the to-be-executed items refer to respective items needed to be completed by the user, for example, in a physical examination center, physical examination items needed to be completed by the user, or in an amusement park, amusement items needed to be completed by the user, and the like.

The candidate queuing schemes refer to different queuing schemes obtained according to the number of to-be-executed items and different orderings between the items, for example, if the to-be-executed items of the user are item x and item y, there are two candidate queuing schemes, one is x, y and the other is y, x.

If the number of to-be-executed items is large, the respective candidate queuing schemes are obtained based on different permutations of the items. For example, if the to-be-executed items of the user are items a, b and c respectively, there are a total of 6 candidate queuing schemes obtained according to different permutations, i.e., abc, acb, bac, bca, cab and cba; and if the to-be-executed items of the user are items a, b, c and d respectively, there are a total of 24 candidate queuing schemes obtained according to different permutations, and the specific permutation method is similar to the above method, which is not repeated herein.

In each of the candidate queuing schemes, the item arranged first in order is the first-order item, and the to-be-executed item other than the first-order item is the other item. For example, in the candidate queuing schemes x, y, the item x is the first-order item and the item y is the other item.

In the exemplary embodiment, during obtaining the plurality of different candidate queuing schemes, it may first use each of the to-be-executed items as the first-order item in turn, and then determine the order of the other items in turn, so as to obtain a plurality of different candidate queuing schemes.

In step S120, for each of the candidate queuing schemes, it obtains a completion time for the first-order item according to a number of current queueing people for the first-order item and a unit execution time for the first-order item.

In an exemplary embodiment, the unit execution time for the first-order item refers to the time required for a single person to complete the first-order item, and the unit execution time may be a fixed time value or an average value, which is not specifically limited herein. For example, the unit execution time for a physical examination item refers to the time required for a single person to complete the examination for that item.

In an exemplary embodiment, the number of current queueing people for the first-order item may be obtained from the number of people allocated by a physical examination system for each physical examination item. In an exemplary embodiment, the number of current queuing people for the first-order item may also be obtained by obtaining the surveillance image and performing face recognition, i.e., it may obtain the current surveillance image of the first-order item, perform image segmentation on the surveillance image by the face recognition technology, and then obtain the number of current queuing people for the first-order item according to the result of the image segmentation. In addition, the number of current queuing people may also be obtained by some other methods such as sensors, which are not specifically limited in the exemplary embodiment.

The completion time for the first-order item refers to the total time spent by the user at the first-order item, from the start of queuing to the completion of the item by the user himself. For example, if the unit execution time for the first-order item in a certain candidate queuing scheme is t1 and the number of current queuing people is p1, the completion time for the first-order item in that candidate queuing scheme is C₁=t1×(p1+1).

In determining the completion time for the first-order item, the distance travelled may also be taken into account. The specific method may include obtaining a movement distance between the first-order item and a next-order item to the first-order item and movement speed data of the user, obtaining movement time of the user according to a ratio between the movement distance and the movement speed data, and then obtaining the completion time for the first-order item according to the movement time of the user, the number of current queuing people for the first-order item and the unit execution time for the first-order item.

In an exemplary embodiment, the movement time used by the user in moving from the first-order item to the next-order item may be added to the completion time for the first-order item. For example, when determining the next-order item after the first-order item, it obtains the movement distance between the first-order item and the next-order item as s1 and the movement speed data of the user as v1, the completion time for the first-order item is C₁=t1×(p1+1)+s1/ν1.

In step S130, it determines a number of increased queuing people for each of the other items according to the completion time for the first-order item.

In an exemplary embodiment, some additional/new/increased users may appear within a period of time after the user completes a particular item, and these increased users may select different items for queuing according to different needs. The number of increased queuing people refers to the number of queuing people added to each of the other items over a period of time. By estimating the number of increased queuing people for each of the other items within the completion time for the first-order item, the queuing situation of each of the other items may be obtained when the user completes the first-order item.

In an exemplary embodiment, it may estimate the number of increased queuing people from historical data. As shown in FIG. 3, determining the number of the increased queuing people for each of the other items according to the completion time for the first-order item may include the following steps.

In step S310, it obtains historical data of increased users within a plurality of unit time periods, and determines a number of the increased users within the completion time for the first-order item according to the historical data.

The unit time period is the smallest time unit used to calculate the number of increased users over a period of time, and in an exemplary embodiment, the unit time period may be 10 minutes, or 20 minutes, which is not specifically limited in the exemplary embodiment. The historical data of increased users within the unit time period refers to the number of increased users within a historical unit time period in the past, and the collection of the historical data of increased users may be used to estimate the current number of increased users.

In an exemplary embodiment, the historical data of increased users within a plurality of unit time periods may be obtained at random. For example, it is assumed that the unit time period is 10 minutes, the number of increased users within a plurality of 10-minute periods in the past may be randomly collected as the historical data of increased users within the plurality of unit time periods.

In addition, the historical data of increased users within the plurality of unit time periods may be obtained periodically, i.e., it may first obtain a collection period of historical data, and then obtain the historical data of increased users within the unit time period at corresponding time points within each collection period according to the collection period of historical data.

For the physical examination center scenario, the number of users will generally change according to a certain period. For example, if a week is used as the period, there may be a difference between the number of examined people from Monday to Friday in a week and that on the weekend. If a day is used as the period, the number of examined people in the morning may also differ from the number of examined people in the afternoon. Therefore, it is possible to obtain the historical data of the number of increased users within a unit time period according to a certain collection period.

For example, if it needs to estimate the number of increased users in the current hour, the time period to be estimated is from 10:00 to 11:00 on Saturdays, and it takes 20 minutes as the unit time period, based on the periodicity of the historical data, it may obtain the historical data of increased users in the three unit time periods of 10:00 to 10:20, 10:20 to 10:40 and 10:40 to 11:00 every Saturday in the past month. It obtains a total of four sets of data, and each set of data includes data within three unit time periods. The number of increased users within the current time period between 10:00 and 11:00 may be estimated according to the data. By collecting the historical data periodically, it may reduce the impact of data fluctuations on the estimation results.

In addition to the above methods, the historical data may be obtained by a number of other methods, such as averaging method, which is not specifically limited in the exemplary embodiment.

In an exemplary embodiment, the historical data of increased users within the plurality of unit time periods obeys a first probability distribution. The first probability distribution may be a Poisson distribution or may be a distribution type of another form capable of representing the probability of a random event occurring. As shown in FIG. 4, determining the number of the increased users within the completion time for the first-order item according to the historical data may include the following steps.

In step S410, it determines a distribution parameter in the first probability distribution according to the historical data, and determines a number of the unit time periods within the completion time for the first-order item.

In an exemplary embodiment, the first probability distribution may be a Poisson distribution, by which the probability p(n) of the number n of increased users within the unit time periods may be depicted, i.e.,

$$p ( n ) = \frac{{e}^{- λ} \times {λ}^{n}}{n !}$$

where λ is the distribution parameter.

It is assumed that the historical data of increased users within M unit time periods is collected as n1, . . . , nM, and in an exemplary embodiment, the value of λ may be calculated by the maximum likelihood method as follows:

$$max {\prod }_{i = 1}^{M} p ( {n}_{i} ) ⟹ max {\sum }_{i = 1}^{M} ln p ( {n}_{i} ) = max {\sum }_{i - 1}^{M} ( - λ + {n}_{i} ln λ - ln {n}_{i} ! )$$

In order to maximize the value of the above formula, the derivative with respect to λ is made to make the same to be equal to 0, i.e.:

$$\begin{matrix}- M + \frac{{\sum }_{i = 1}^{M} {n}_{i}}{λ} = 0 \\ ⟹ λ = \frac{{\sum }_{i = 1}^{M} {n}_{i}}{M}\end{matrix}$$

In this way, the probability distribution of the number n of increased users within the unit time periods may be determined.

It is assumed that the unit time period is Δt, then

$$T = \frac{{C}_{i}}{Δ t}$$

is used to express the number of unit time periods Δt included in the completion time Cᵢ for the first-order item, and it takes ┌T┐ as the smallest integer greater than T, e.g., 4 if T=3.3.

In step S420, it determining the number of the increased users within the completion time for the first-order item according to the distribution parameter and the number of the unit time periods within the completion time for the first-order item.

It is assumed that the numbers of increased users within the plurality of unit time periods in the completion time Cᵢ for the first-order item are respectively represented as R₁, R₂, . . . , R_{┌T┐}, then the total number of increased users in the time period Cᵢ is

$$R = {\sum }_{j = 1}^{⌈ T ⌉} {R}_{j} .$$

Since Rⱼ obeys the Poisson distribution, R also obeys a certain probability distribution.

In an exemplary embodiment, as shown in FIG. 5, determining the number of the increased users within the completion time for the first-order item according to the distribution parameter and the number of the unit time periods within the completion time for the first-order item in step S420 may specifically include the following steps.

In step S510, it determines the number of the increased users within the completion time for the first-order item based on the first probability distribution according to the distribution parameter and the number of the unit time periods, when the unit time periods within the completion time for the first-order item are all integral unit time periods.

When the unit time periods within the completion time for the first-order item are all integral unit time periods, that is, the value of

$$T = \frac{{C}_{i}}{Δ t}$$

is an integer, the total number R of increased users within the time period Cᵢ has the same probability distribution as that obeyed by Rⱼ, which is a first probability distribution, and therefore the number of increased users within the completion time for the first-order item may be determined directly according to the first probability distribution.

In step S520, it determines a second probability distribution obeyed by the incomplete unit time period according to the first probability distribution obeyed by the integral unit time period, when the unit time periods within the completion time for the first-order item includes the integral unit time period and an incomplete unit time period.

When the unit time period within the completion time for the first-order item includes the integral unit time period and the incomplete unit time period, i.e., the value of

$$T = \frac{{C}_{i}}{Δ t}$$

is not an integer, the number of increased users within the incomplete unit time period may not obey the first probability distribution. Therefore, the number of increased users within the incomplete unit time period obeys the second probability distribution, and the second probability distribution may be a Poisson distribution or a uniform distribution. When the second probability distribution and the first probability distribution both obey the Poisson distribution, the distribution parameters thereof are different, so that the number of increased users within the integral unit time period and that within the incomplete unit time period need to be calculated according to the different probability distributions.

In step S530, it determines a first number of the increased users within the integral unit time period based on the first probability distribution according to the distribution parameter and the number of the integral unit time periods.

In an exemplary embodiment, the number of increased users within the time period Cᵢ may be estimated from the expected value of R. In this case, the specific method of step S530 may include: determining an expected value of the first number of the increased users based on first probability distribution according to the distribution parameter and the number of the integral unit time periods; and using the expected value of the first number of the increased users as the first number of the increased users for the integral unit time period within the completion time for the first-order item. When the first probability distribution is a Poisson distribution, the corresponding formula for this step is as follows:

$${\sum }_{j = 1}^{⌈ T ⌉ - 1} E ( {R}_{j} ) = ( ⌈ T ⌉ - 1 ) \times λ$$

where the number of integral unit time periods is ┌T┐−1.

In step S540, it determines a second number of the increased users within the incomplete unit time period based on the second probability distribution according to the distribution parameter.

In an exemplary embodiment, the expected value of the second number of increased users may be determined based on the second probability distribution according to the distribution parameter, and the expected value of the second number of increased users may be used as the second number of increased users within the incomplete unit time period in the completion time for the first-order item. Assuming that the second probability distribution is a uniform distribution, the formula for calculating the second number of increased users within the incomplete unit time period is as follows:

E(R_{┌T┐})=(T−┌T┐+1)×λ

In step S550, it determines the number of the increased users within the completion time for the first-order item according to the first number of the increased users and the second number of the increased users.

With the above steps, it may obtain that the number of the increased users within the completion time for the first-order item is a sum of the first number of the increased users and the second number of the increased users, i.e.,

$$\begin{matrix}E ( R ) = E ( {\sum }_{j = 1}^{⌈ T ⌉ - 1} {R}_{j} ) = {\sum }_{j = 1}^{⌈ T ⌉} E ( {R}_{j} ) \\ = {\sum }_{j = 1}^{⌈ T ⌉ - 1} E ( {R}_{j} ) + E ( {R}_{⌈ T ⌉} ) \\ = ( ⌈ T ⌉ - 1 ) \times λ + ( T - ⌈ T ⌉ + 1 ) \times λ = T \times λ \\ = T \times \frac{{\sum }_{i = 1}^{M} {n}_{i}}{M}\end{matrix}$$

Based on steps S510 to S550, it may estimate the number of increased users within the completion time for the first-order item through the expected value E(R) of the total number R of increased users within the time period Cᵢ.

In step S320, it determines the number of the increased queuing people for each of the other items within the completion time for the first-order item according to the number of the increased users within the completion time for the first-order item.

Once the number of increased users within the completion time for the first-order item is obtained, the number of increased queuing people for each of the other items within the completion time for the first-order item may be further estimated.

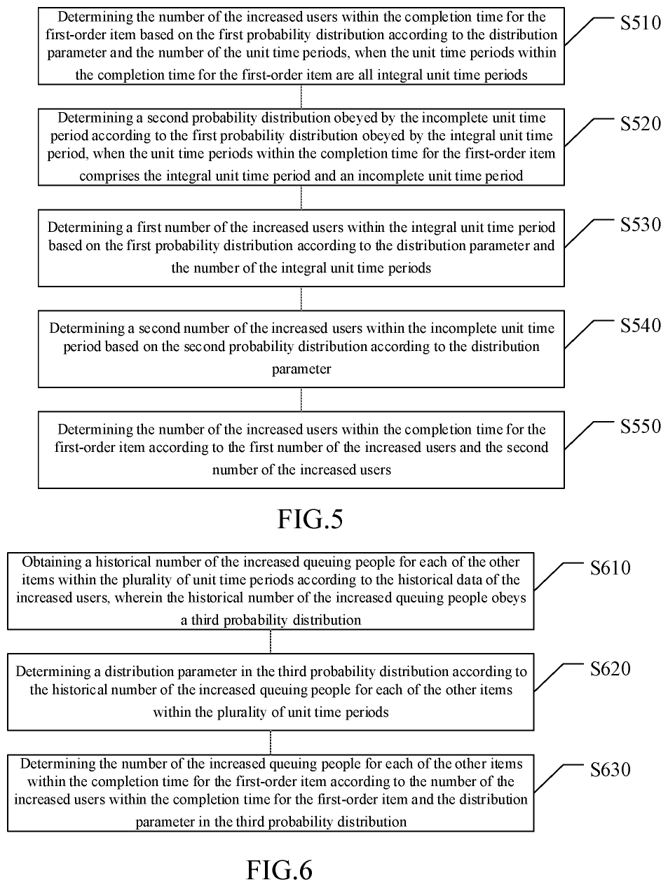

In an exemplary embodiment of the present disclosure, as shown in FIG. 6, determining the number of the increased queuing people for each of the other items within the completion time for the first-order item according to the number of the increased users within the completion time for the first-order item of step 320 may specifically comprise the following steps.

In step S610, it obtains a historical number of the increased queuing people for each of the other items within the plurality of unit time periods according to the historical data of the increased users, wherein the historical number of the increased queuing people obeys a third probability distribution.

From the historical data of the increased users, the historical number of the increased queuing people for each of the other items within each unit time period may be obtained. First, it may obtain, according to the collection in L unit time periods D₁, . . . , D_{L}, the number Nᵢ of increased users within each unit time period Dᵢ, and the numbers d₁ⁱ, d₂ⁱ, . . . ., d_{N}ⁱ of users respectively choosing queuing items a1, a2, aN of the Nᵢ increased users. As the historical data of the increased users is data distributed across a plurality of items, the third probability distribution in an exemplary embodiment may be a polynomial distribution or may be of another distribution type capable of representing a polynomial parameter probability distribution.

In step S620, it determines a distribution parameter in the third probability distribution according to the historical number of the increased queuing people for each of the other items within the plurality of unit time periods.

In step S630, it determines the number of the increased queuing people for each of the other items within the completion time for the first-order item according to the number of the increased users within the completion time for the first-order item and the distribution parameter in the third probability distribution.

The number of increased users within the completion time for the first-order item obtained in the above step is denoted N. In order to estimate the queuing of increased users on items a1, a2, . . . , aN, it is assumed that the probabilities of d1, d2, . . . , dN users of the N increased users queuing for items a1, a2, . . . , aN are:

$$p ( {d}_{1} , {d}_{2} , … , {d}_{N} ) = \frac{N !}{{d}_{1} ! {d}_{2} ! … {d}_{N} !} {p}_{1}^{{d}_{1}} {p}_{2}^{{d}_{2}} … {p}_{N}^{{d}_{N}} where ,$$

$$N = {d}_{1} + {d}_{2} + … + {d}_{N} , {\sum }_{i = 1}^{N} {p}_{i} = 1$$

where pᵢ denotes the probability that a user queues for item ai.

In order to calculate the above polynomial distribution, it is necessary to know the value of the probability pᵢ(i=1, N). Likewise, in an exemplary embodiment, the value of pᵢ may be calculated by the maximum likelihood method, then in order to make the probability of the above data occurring have a maximum value:

$$max {\prod }_{i = 1}^{L} p ( {d}_{1}^{′} , {d}_{2}^{′} , … , {d}_{N}^{′} ) \text{=>} max {\sum }_{i = 1}^{L} log p ( {d}_{1}^{i} , {d}_{2}^{i} , … , {d}_{N}^{i} ) = max {\sum }_{i = 1}^{L} ( log \frac{{N}_{1} !}{{d}_{1}^{i} ! … {d}_{N}^{i} !} + {\sum }_{j = 1}^{N} {d}_{j}^{i} log {p}_{j} )$$

$$s . t . {\sum }_{i = 1}^{N} {p}_{i} = 1$$

When the derivative with respect to pᵢ (i=1, N) is made by using the Lagrange multiplier method, it may obtain:

$$f = {\sum }_{i = 1}^{L} ( log \frac{{N}_{1} !}{{d}_{1}^{i} ! … {d}_{N}^{i} !} + {\sum }_{j = 1}^{N} {d}_{j}^{i} log {p}_{j} ) + λ ( 1 - {\sum }_{j = 1}^{N} {p}_{j} )$$

The derivative of f with respect to pᵢ is made to make the same to be 0, it may obtain:

$$\frac{{\sum }_{i = 1}^{L} {d}_{j}^{i}}{{p}_{j}} - λ = 0 \qquad ( 1 )$$

The derivative of f with respect to λ is made to make the same to be 0, it may obtain:

$$1 - {\sum }_{j = 1}^{N} {p}_{j} = 0 \qquad ( 2 )$$

It may obtain from formula (1):

$${p}_{j} = \frac{{\sum }_{i = 1}^{L} {d}_{j}^{i}}{λ}$$

It may obtain from formula (1):

$$1 - {\sum }_{j = 1}^{N} \frac{{\sum }_{i = 1}^{L} {d}_{j}^{i}}{λ} = 0$$

$$= > λ = {\sum }_{j = 1}^{N} {\sum }_{i = 1}^{L} {d}_{j}^{′} = {\sum }_{i = 1}^{L} {\sum }_{j = 1}^{N} {d}_{j}^{′} = {\sum }_{i = 1}^{L} {N}_{i}$$

From formulas (1) and (2), it may obtain the probability pⱼ as:

$${p}_{j} = \frac{{\sum }_{i = 1}^{L} {d}_{j}^{i}}{{\sum }_{i = 1}^{L} {N}_{i}}$$

Similarly, in an exemplary embodiment, the situations of the users queuing for items a1, a2, . . . , aN may be estimated by using an expected value. That is, the expectation is used in this example implementation to estimate the queuing of users on items a1, a2, . . . , aN. That is, it determines an expected value of the number of the increased queuing people for each of the other items according to the number of the increased users within the completion time for the first-order item and the distribution parameter in the third probability distribution; and then uses the expected value of the number of the increased queuing people as the number of the increased queuing people for each of the other items within the completion time for the first-order item.

Based on the above calculation process, the expected value of the number of increased queuing people for each of the other items is:

$${E}_{j} = N \times \frac{{\sum }_{i = 1}^{L} {d}_{j}^{i}}{{\sum }_{i = 1}^{L} {N}_{i}} , ( j = 1 , 2 , … , N )$$

Based on steps S610 to S630, it may estimate the number of the increased queuing people for each of the other items within the completion time for the first-order item according to the expected value Eⱼ of the number of the increased queuing people for each of the other items within the time period Cᵢ.

With continued reference to FIG. 1, in step S140, it obtains the completion time for all the other items according to the number of the current queuing people, the number of the increased queuing people and a corresponding unit execution time for each of the other items.

In an exemplary embodiment, it may obtain the completion time for all the other items according to different numbers of iterations and according to the number of the current queuing people, the number of the increased queuing people and the corresponding unit execution time for each of the other items.

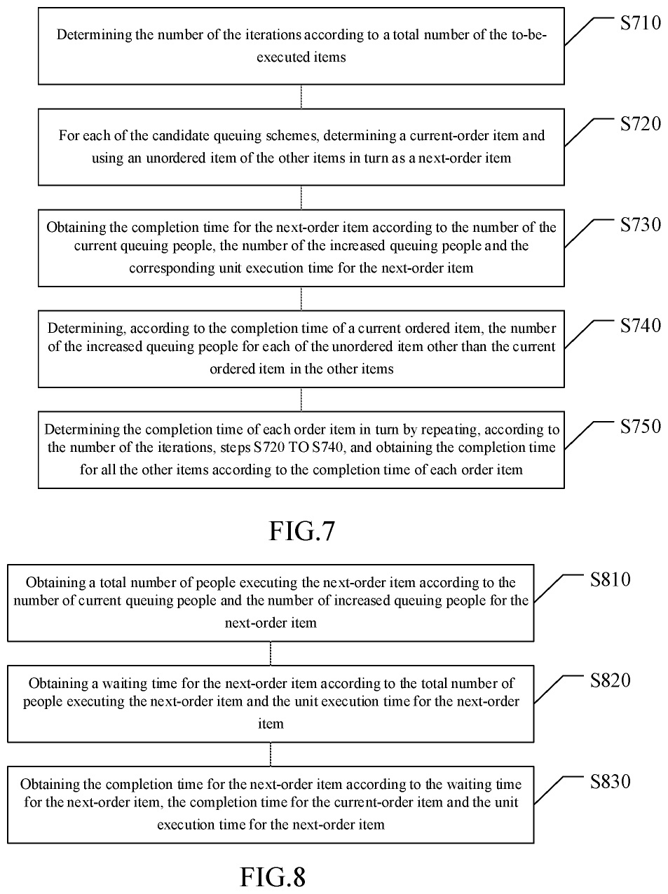

If the number of iterations is determined based on the total number of items, as shown in FIG. 7, in step S140, it obtains the completion time for all the other items by performing iteration according to the number of iterations and according to the number of the current queuing people, the number of the increased queuing people and the corresponding unit execution time for each of the other items, which may include the following steps.

In step S710, it determines the number of the iterations according to a total number of the to-be-executed items.

In an exemplary embodiment, the number of iterations may be determined based on the total number of the to-be-executed items, i.e., the completion times of all items are iterated for calculation. In this case, a more accurate estimate may be obtained. For example, if the total number of the items to be executed by the user is 5, the number of remaining items other than the first-order item is 4. In this case, the number of iterations of the completion times of all other items is 4, which is the same as the number of the other items.

In step S720, for each of the candidate queuing schemes, it determines a current-order item and uses an unordered item of the other items in turn as a next-order item.

In an exemplary embodiment, the current-order item refers to an order item that has been ordered in the latest round corresponding to the current iteration round. For each of the candidate queuing schemes, after determining the current-order item, an unordered item is selected from the other items as the next-order item arranged in order after the current-order item. For example, if the current iteration is the first iteration, the current-order item is the first-order item and the next-order item to the current-order item is the second-order item.

In step S730, it obtains the completion time for the next-order item according to the number of the current queuing people, the number of the increased queuing people and the corresponding unit execution time for the next-order item.

As shown in FIG. 8, obtaining the completion time for the next-order item according to the number of the current queuing people, the number of the increased queuing people and the corresponding unit execution time for the next-order item of step S730 may specifically include the following steps.

In step S810, it obtains a total number of people executing the next-order item according to the number of the current queuing people and the number of the increased queuing people for the next-order item.

It may obtain the total number of people executing the next-order item according to the sum of the number of the current queuing people and the number of the increased queuing people for the next-order item. For example, if the current-order item is the first-order item, the next-order item is the second-order item. In the above step, the number of increased queuing people for each of the other items than the first-order item within the completion time for the first-order item has been obtained, so the number of current queuing people and the number of increased queuing people for the second-order item may be obtained directly, and the total number of people executing the second-order item may be obtained according to the sum of the number of current queuing people and the number of increased queuing people for the second-order item.

In step S820, it obtains a waiting time for the next-order item according to the total number of people executing the next-order item and the unit execution time for the next-order item.

The waiting time for the next-order item is obtained according to the product of the total number of people executing the next-order item and the unit execution time for the next-order item.

In step S830, it obtains the completion time for the next-order item according to the waiting time for the next-order item, the completion time for the current-order item and the unit execution time for the next-order item.

In an exemplary embodiment, the completion time for the next-order item is obtained by adding the difference between the waiting time for the next-order item and the completion time for the current-order item to the unit execution time required by the user itself to complete the next-order item.

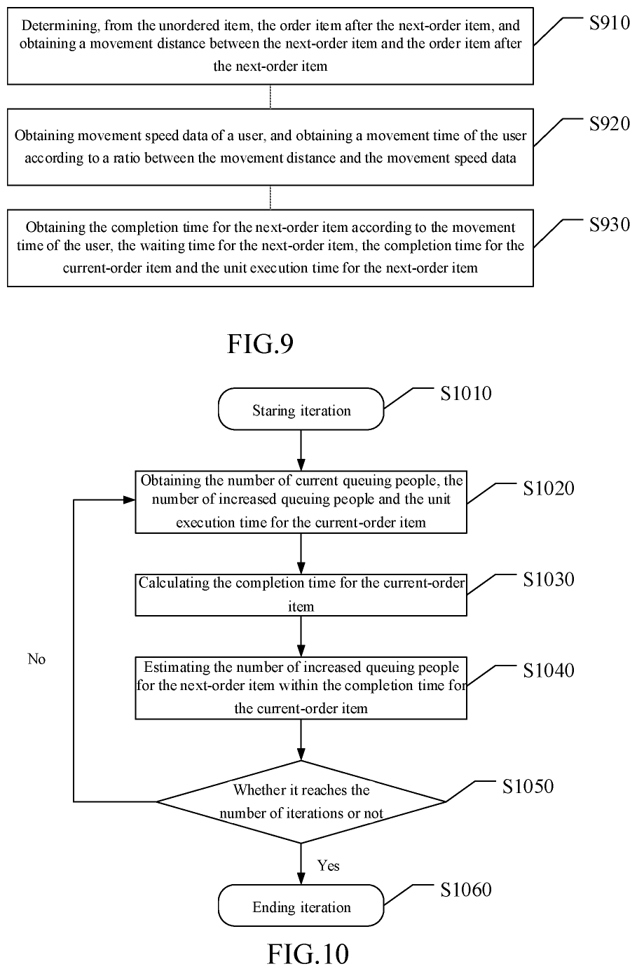

Each time determining the completion time for the next-order item, similar to the calculating method of the completion time for the first-order item, the travelled distance may also be taken into account, as shown in FIG. 9, which may specifically include:

step S910, determining, from the unordered item, the order item after the next-order item, and obtaining a movement distance between the next-order item and the order item after the next-order item;

step S920, obtaining movement speed data of a user, and obtaining a movement time of the user according to a ratio between the movement distance and the movement speed data; and

step S930, obtaining the completion time for the next-order item according to the movement time of the user, the waiting time for the next-order item, the completion time for the current-order item and the unit execution time for the next-order item.

Before proceeding to the next iteration, the movement time of the movement from the next-order item to the order item after the next-order item may be added to the completion time for the next-order item. The specific method is similar to the method used in step S120 to obtain the completion time for the first-order item according to the movement time between the first-order item and the next-order item to the first-order item, which is not repeated here.

After the completion time for the next-order item is calculated, when the completion time for the next-order item is positive, it means that the number of queuing people for the next-order item after the user has completed the current-order item is positive. Therefore, when the sum of the waiting time for the next-order item and the unit execution time for the next-order item is greater than or equal to the completion time for the current-order item, the completion time for the next-order item is obtained according to the waiting time for the next-order item, the completion time for the current-order item and the unit execution time for the next-order item.

In another case, the completion time for the next-order item may also be zero or a negative number, i.e., when the user complete the current-order item, or during the completion of the current-order item, all the people for the next-order item has already completed the next-order item, and the user may execute the next-order item without queuing. Thus, in the case where the sum of the waiting time for the next-order item and the unit execution time for the next-order item is less than the completion time for the current-order item, the unit execution time for the next-order item is directly used as the completion time for the next-order item.

In step S740, it determines, according to the completion time of a current ordered item, the number of the increased queuing people for each of the unordered item other than the current ordered item in the other items.

The completion times for the current ordered items are added together, and the number of increased queuing people for each of the other items other than the current ordered items is again estimated within this period of time. The method is similar to the method in step S130 and is not repeated here.

In step S750, it determines the completion time of each order item in turn by repeating, according to the number of the iterations, steps S720 to S740, and obtains the completion time for all the other items according to the completion time of each order item.

Steps S720 to S740 are repeated according to the number of iterations, and the completion times for the third-order item, the fourth-order item and so on of the to-be-executed items are estimated in turn, until the completion times for all items are estimated by the above steps. The specific iterative method is shown in FIG. 10.

In step S1010, the iteration starts.

In step S1020, it obtains the number of current queuing people, the number of increased queuing people and the unit execution time for the current-order item.

In step S1030, it calculates the completion time for the current-order item.

It calculates the completion time for the current-order item according to the number of current queuing people, the number of increased queuing people and the unit execution time for the current-order item.

In step S1040, it estimates the number of increased queuing people for the next-order item within the completion time for the current-order item.

In step S1050, it determines whether the number of iterations has been reached.

If the number of iterations has not been reached, it returns to step S1020, and if the number of iterations has been reached, it goes to step S1060 and the iteration process ends.

In step S1060, the iteration ends.

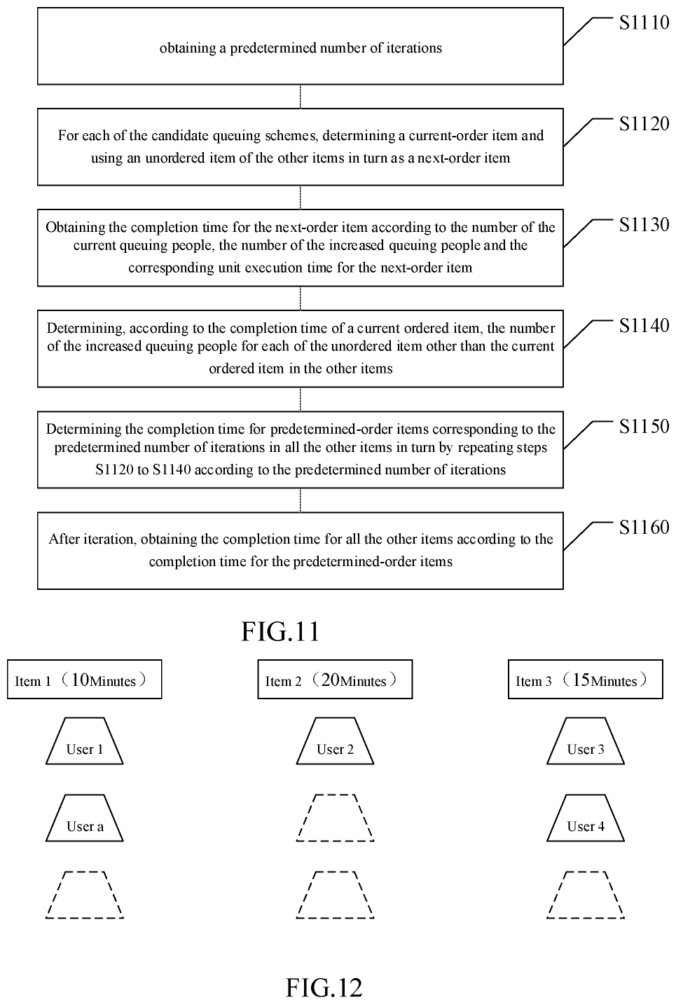

In an exemplary embodiment, the iteration calculation may also be performed according to a predetermined number of iterations. As shown in FIG. 11, in step S140, obtaining the completion time for all the other items by performing iteration according to a number of iterations and according to the number of the current queuing people, the number of the increased queuing people and the corresponding unit execution time for each of the other items may specifically include:

step S1110, obtaining a predetermined number of iterations;

step S1120, for each of the candidate queuing schemes, determining a current-order item and using an unordered item of the other items in turn as a next-order item;

step S1130, obtaining the completion time for the next-order item according to the number of the current queuing people, the number of the increased queuing people and the corresponding unit execution time for the next-order item;

step S1140, determining, according to the completion time of a current ordered item, the number of the increased queuing people for each of the unordered item other than the current ordered item in the other items;

step S1150, determining the completion time for predetermined-order items corresponding to the predetermined number of the iterations in all the other items in turn by repeating steps S1120 to S1150 according to the predetermined number of the iterations; and

step S1160, after the iteration, obtaining the completion time for all the other items according to the completion time for the predetermined-order items.

If the number of the to-be-executed items is too large, e.g., if the total number of items is 20, or 30, etc., the iteration calculation of all the items will result in too many calculations. Therefore, it may set a predetermined number of iterations, stop the iteration after a fixed number of iterations, and estimate the completion time for each of the other items according to the completion time for the predetermined-order items obtained from the predetermined number of iterations. The specific iteration method is shown in FIG. 10 and will not be repeated here.

By setting the predetermined number of iterations and approximating the completion time for each of the other items according to the completion time for the predetermined-order items obtained from the predetermined number of iterations, the complexity of the calculation may be greatly reduced and the efficiency of the calculation may be improved.

For example, if the user selects the first-order item as item i, the user needs the time Tᵢ=(pᵢ+1)×t to complete the item i. For an other item j, according to the number of current queuing people and the number of increased queuing people, the waiting time for item j may be obtained as Wⱼ=tj×(pj+Eⱼ) (j=1, 2, . . . , N, j≠i), and thus the user needs the time max(pⱼ, Wⱼ−Tᵢ+pⱼ) to complete the item j. If max(pⱼ, Wⱼ−Tᵢ−pⱼ) is denoted as Fⱼ, the lower time limit for the user to complete item i and item j is max(Fj)+Ti, where j=1, 2, . . . , i−1, i+1, . . . , N. To minimize the lower time limit of the user for waiting,

$$i = {min}_{i} ( {max}_{j} ( {F}_{j} ) + {T}_{i} ) = {min}_{i} ( {max}_{j} ( max ( {p}_{j} + {T}_{i} , {W}_{j} + {p}_{j} ) ) )$$

is taken as the item i that the user selects to queue for. If the predetermined number of iterations is taken to be 1, the completion time for all the items may be estimated according to the lower time limit for the completion of the first two items.

With continued reference to FIG. 1, in step S150, it calculates a total time for completion of all the to-be-executed items in each of the candidate queuing schemes, and determines a target queuing scheme according to the total time.

After the completion times of all the to-be-executed items are added up, the total time for the completion of all the to-be-executed items is obtained, and the candidate queuing scheme with the smallest total time is determined as the target queuing scheme to be recommended to the user for reference.

For example, as shown in FIG. 12, it is assumed that there are three to-be-executed items, i.e., item 1 (having an unit execution time of 10 minutes), item 2 (having an unit execution time of 20 minutes) and item 3 (having an unit execution time of 15 minutes), in which the solid trapezoid indicates the current queuing user and the dashed trapezoid indicates the user expected to be increased for queuing. The user a needs 20 minutes to complete item 1. Within the time period of 20 minutes, 4 users are increased newly and the queuing situation is shown in the dashed trapezoid, and then the user needs the time 20*4-20=60 minutes to complete item 2. If the user a completes item 3 first after completing item 1, the user will need 15*4-20=40 minutes, then within the 40 minutes, new user will join the queue, and through the recursive analysis method, it may estimate the total time of the user for the physical examination.

However, the recursive method is very time consuming for large amounts of data, so in an exemplary embodiment, it estimates by using a lower time limit required for the physical examination, and the smaller the lower time limit, the less time the user is likely to take for the physical examination. From the above analysis, it can be seen that the minimum time for user a to complete the three items is 80 minutes, this is because it takes 20 minutes to complete item 1, and in consideration of the increased user within these 20 minutes, it takes at least 60 minutes to complete item 2, therefore the time for user a to complete the physical examination is greater than or equal to 20+60=80 minutes. Another situation is that user a takes 20 minutes to complete item 1, then goes to another item which takes 40 minutes, then goes to item 2. At this time, all the queuing users for item 2 have completed their examination, user a can directly take the examination of item 2 which takes 20 minutes, and the total time in this situation is 80 minutes. The same method is used to obtain the lower time limit for each situation, and then the situation with the smallest lower time limit is taken as the optimal queuing scheme.

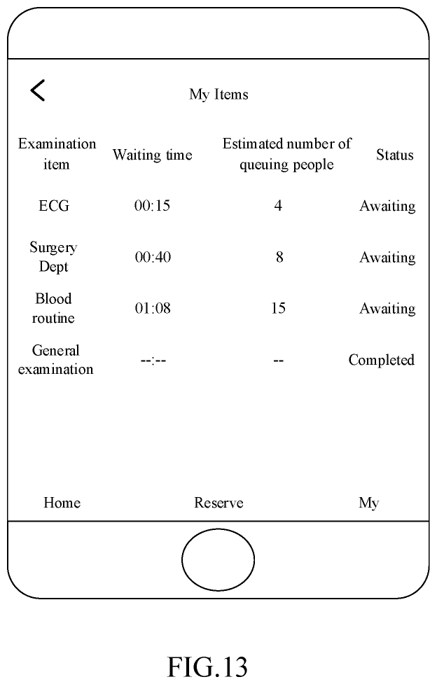

Finally, the queuing scheme determined by the above steps may be pushed to the user. As shown in FIG. 13, it schematically illustrates a schematic diagram of an output of a queuing system for physical examination according to a specific embodiment of the present disclosure. After the calculation by the method for determining the queuing scheme in the exemplary embodiment, the calculation result may be displayed on a system interface to be pushed to the user. The diagram shows that if the user first selects the ECG item, both the total time required and the number of people expected to queue are smallest, so this scheme is the determined target queuing scheme, which is displayed first among all schemes for the user's reference.

In addition, for some special items, such as those that require fasting or should be sequential, due to the special needs of these items, it is not necessary to determine their orders in the target queuing scheme through the above steps, but rather to obtain the queuing requirement for the special item and arrange the special item in a specified position in the target queuing scheme according to the queuing requirement for the special item. For example, for the item in the physical examination items that requires fasting, it is placed directly in the first position in the queuing scheme.

It should be noted that although individual steps of the method in the present disclosure are depicted in the accompanying drawings in a particular order, it is not required or implied that the steps must be performed in that particular order or that all of the steps shown must be performed to achieve the desired result. Additional or alternatively, some steps may be omitted, multiple steps may be combined into a single step for execution, and/or a single step may be divided into multiple steps for execution, and the like.

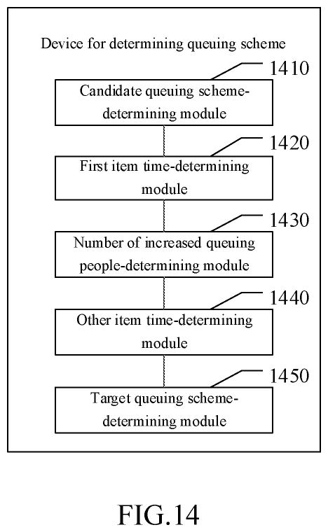

Additionally, the present disclosure further provides a device for determining a queuing scheme. As shown in FIG. 14, the device for determining the queuing scheme may include:

a candidate queuing scheme-determining module 1410, configured to obtain a plurality of candidate queuing schemes by using each of to-be-executed items in turn as a first-order item and using the to-be-executed item other than the first-order item as other items;

a first item time-determining module 1420, configured to, for each of the candidate queuing schemes, obtain a completion time for the first-order item according to a number of current queueing people for the first-order item and a unit execution time for the first-order item;

a number of increased queuing people-determining module 1430, configured to determine a number of increased queuing people for each of the other items according to the completion time for the first-order item;

an other item time-determining module 1440, configured to obtain the completion time for all the other items according to the number of the current queuing people, the number of the increased queuing people and a corresponding unit execution time for each of the other items; and

a target queuing scheme-determining module 1450, configured to calculate a total time for completion of all the to-be-executed items in each of the candidate queuing schemes, and determine a target queuing scheme according to the total time.

In some exemplary embodiments of the present disclosure, the other item time-determining module 1440 may include an iteration unit, configured to obtain the completion time for all the other items by performing iteration according to a number of iterations and according to the number of the current queuing people, the number of the increased queuing people and the corresponding unit execution time for each of the other items.

In some exemplary embodiments of the present disclosure, the iteration unit may include:

a number of iterations-determining unit, configured to determine the number of the iterations according to a total number of the to-be-executed items;

a next item-determining unit, configured to, for each of the candidate queuing schemes, determine a current-order item and use an unordered item of the other items in turn as a next-order item;

a next item time-calculating unit, configured to obtain the completion time for the next-order item according to the number of the current queuing people, the number of the increased queuing people and the corresponding unit execution time for the next-order item;

a number of increased people-determining unit, configured to determine, according to the completion time of a current ordered item, the number of the increased queuing people for each of the unordered item other than the current ordered item in the other items; and

an iteration step-repeating unit, configured to determine the completion time of each order item in turn by repeating, according to the number of the iterations, the step of determining the next item, the step of calculating the completion time and the step of determining the number of the increased people, and obtain the completion time for all the other items according to the completion time of each order item.

In some exemplary embodiments of the present disclosure, the iteration unit may further include:

a predetermined number of iterations-obtaining unit, configured to obtain a predetermined number of iterations;

a next item-determining unit, configured to, for each of the candidate queuing schemes, determine a current-order item and use an unordered item of the other items in turn as a next-order item;

a next item time-calculating unit, configured to obtain the completion time for the next-order item according to the number of the current queuing people, the number of the increased queuing people and the corresponding unit execution time for the next-order item;

a number of increased people-determining unit, configured to determining, according to the completion time of a current ordered item, the number of the increased queuing people for each of the unordered item other than the current ordered item in the other items;

an iteration step-repeating unit, configured to determine the completion time for predetermined-order items corresponding to the predetermined number of the iterations in all the other items in turn by repeating, according to the predetermined number of the iterations, the step of determining the next item, the step of calculating the completion time, and the step of determining the number of the increased people; and

an other item time unit, configured to after the iteration, obtain the completion time for all the other items according to the completion time for the predetermined-order items.

In some exemplary embodiments of the present disclosure, the first item time-determining module 1420 may include:

a first movement distance-obtaining unit, configured to obtain a movement distance between the first-order item and the next-order item to the first-order item;

a first movement time-determining unit, configured to obtain movement speed data of a user, and obtain a movement time of the user according to a ratio between the movement distance and the movement speed data; and

a first completion time-determining unit, configured to obtain the completion time for the first-order item according to the movement time of the user, the number of the current queueing people for the first-order item and the unit execution time for the first-order item.

In some exemplary embodiments of the present disclosure, the next item time-calculating unit may include:

a total number of people executing the next item-determining unit, configured to obtain a total number of people executing the next-order item according to the number of the current queuing people and the number of the increased queuing people for the next-order item;

a waiting time for the next item-determining unit, configured to obtain a waiting time for the next-order item according to the total number of people executing the next-order item and the unit execution time for the next-order item; and

a completion time for the next item-calculating unit, configured to obtain the completion time for the next-order item according to the waiting time for the next-order item, the completion time for the current-order item and the unit execution time for the next-order item.

In some exemplary embodiments of the present disclosure, the completion time for the next item-calculating unit may include:

a first situation-calculating unit, configured to obtain the completion time for the next-order item according to the waiting time for the next-order item, the completion time for the current-order item and the unit execution time for the next-order item when a sum of the waiting time for the next-order item and the unit execution time for the next-order item is greater than or equal to the completion time for the current first-order item; and

a second situation-calculating unit, configured to take the unit execution time for the next-order item as the completion time for the next-order item when the sum of the waiting time for the next-order item and the unit execution time for the next-order item is smaller than the completion time for the current-order item.

In some exemplary embodiments of the present disclosure, the completion time for the next item-calculating unit may include:

a second movement distance-obtaining unit, configured to determine, from the unordered item, the order item after the next-order item, and obtain a movement distance between the next-order item and the order item after the next-order item;

a second movement time-determining unit, configured to obtain movement speed data of a user, and obtain a movement time of the user according to a ratio between the movement distance and the movement speed data; and

a second completion time-calculating unit, configured to obtain the completion time for the next-order item according to the movement time of the user, the waiting time for the next-order item, the completion time for the current-order item and the unit execution time for the next-order item.

In some exemplary embodiments of the present disclosure, the number of increased queuing people-determining module 1430 may include:

a number of increased users-determining unit, configured to obtain historical data of increased users within a plurality of unit time periods, and determine a number of the increased users within the completion time for the first-order item according to the historical data; and

a number of the increased queuing people-determining unit, configured to determine the number of the increased queuing people for each of the other items within the completion time for the first-order item according to the number of the increased users within the completion time for the first-order item.

In some exemplary embodiments of the present disclosure, the number of increased users-determining unit may include:

a historical data period-obtaining unit, configured to obtain a collection period for the historical data; and

a historical data-obtaining unit, configured to obtain the historical data of the increased users within the unit time period of corresponding time points in each collection period according to the collection period for the historical data.

In some exemplary embodiments of the present disclosure, the number of increased users-determining unit may further include: a historical data-randomly obtaining unit, configured to randomly obtain the historical data of the increased users within the plurality of unit time periods.

In some exemplary embodiments of the present disclosure, the number of increased users-determining unit may further include:

a first distribution parameter-determining unit, configured to determine a distribution parameter in the first probability distribution according to the historical data, and determine a number of the unit time periods within the completion time for the first-order item; and

a number of increased users-calculating unit, configured to determine the number of the increased users within the completion time for the first-order item according to the distribution parameter and the number of the unit time periods within the completion time for the first-order item.

In some exemplary embodiments of the present disclosure, the number of increased users-calculating unit may include:

a number of increased users within completion time-determining unit, configured to determine the number of the increased users within the completion time for the first-order item based on the first probability distribution according to the distribution parameter and the number of the unit time periods, when the unit time periods within the completion time for the first-order item are all integral unit time periods;

a second probability distribution-determining unit, configured to determine a second probability distribution obeyed by the incomplete unit time period according to the first probability distribution obeyed by the integral unit time period, when the unit time periods within the completion time for the first-order item includes the integral unit time period and an incomplete unit time period;

a first number of increased users-determining unit, configured to determine a first number of the increased users within the integral unit time period based on the first probability distribution according to the distribution parameter and the number of the integral unit time periods;

a second number of increased users-determining unit, configured to determine a second number of the increased users within the incomplete unit time period based on the second probability distribution according to the distribution parameter; and

a total number of increased users-determining unit, configured to determine the number of the increased users within the completion time for the first-order item according to the first number of the increased users and the second number of the increased users.

In some exemplary embodiments of the present disclosure, the first number of increased users-determining unit may include:

a first expected value-determining unit, configured to determine an expected value of the first number of the increased users based on first probability distribution according to the distribution parameter and the number of the integral unit time periods; and

a first number of increased users-calculating unit, configured to use the expected value of the first number of the increased users as the first number of the increased users for the integral unit time period within the completion time for the first-order item.

In some exemplary embodiments of the present disclosure, the second number of increased users-determining unit may include:

a second expected value-determining unit, configured to determine an expected value of the second number of the increased users based on the second probability distribution according to the distribution parameter; and

a second number of increased users-calculating unit, configured to use the expected value of the second number of the increased users as the second number of the increased users for the incomplete unit time period within the completion time for the first-order item.

In some exemplary embodiments of the present disclosure, the number of increased queuing people-calculating unit may include:

a historical number of increased queuing people-obtaining unit, configured to obtain a historical number of the increased queuing people for each of the other items within the plurality of unit time periods according to the historical data of the increased users, wherein the historical number of the increased queuing people obeys a third probability distribution;

a third distribution parameter-determining unit, configured to determine a distribution parameter in the third probability distribution according to the historical number of the increased queuing people for each of the other items within the plurality of unit time periods; and

a first number of increased queuing people-determining unit, configured to determine the number of the increased queuing people for each of the other items within the completion time for the first-order item according to the number of the increased users within the completion time for the first-order item and the distribution parameter in the third probability distribution.

In some exemplary embodiments of the present disclosure, the first number of increased queuing people-determining unit may include:

an expected value of the number of increased people-determining unit, configured to determine an expected value of the number of the increased queuing people for each of the other items according to the number of the increased users within the completion time for the first-order item and the distribution parameter in the third probability distribution; and

a first number of increased queuing people-calculating unit, configured to use the expected value of the number of the increased queuing people as the number of the increased queuing people for each of the other items within the completion time for the first-order item.

In some exemplary embodiments of the present disclosure, the device for determining the queuing scheme provided by the present disclosure may further include:

a monitoring image segmentation module, configured to obtain a current monitoring image of the first-order item and perform an image segmentation on the monitoring image by means of face recognition technology; and

a number of current queuing people-determining module, configured to obtain the number of current queuing people for the first-order item according to the result of the image segmentation.

In some exemplary embodiments of the present disclosure, the target queuing scheme-determining module 1450 may include a total time-determining unit configured to determine the candidate queuing scheme with a least total time as the target queuing scheme.

The specific details of the modules in the above-mentioned device for determining the queuing scheme are described in detail in the corresponding method embodiments and will not be repeated here.

The modules/units may be implemented on the basis of hardware/software/firmware or may be implemented with a combination of dedicated hardware and computer instructions.

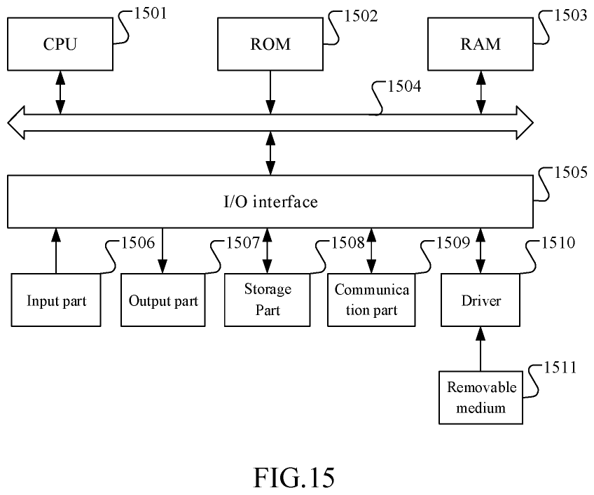

FIG. 15 illustrates a schematic structure diagram of a computer system suitable for implementing an electronic device according to an embodiment of the present disclosure.

It is noted that the computer system 1500 of the electronic device illustrated in FIG. 15 is only an example and should not impose any limitations on the functionality and use scope of the embodiments of the present disclosure.

As shown in FIG. 15, the computer system 1500 includes a central processing unit (CPU) 1501 which may perform various appropriate actions and processes based on a program stored in a read-only memory (ROM) 1502 or loaded into a random access memory (RAM) 1503 from a storage part 1508. In RAM 1503, various programs and data required for system operation are also stored. The CPU 1501, ROM 1502 and RAM 1503 are connected to each other via bus 1504. The input/output (I/O) interface 1505 is also connected to the bus 1504.

The following components are connected to the I/O interface 1505: an input part 1506 including keyboard, mouse and the like; an output part 1507 including, for example, cathode ray tube (CRT), liquid crystal display (LCD), and speaker and the like; a storage part 1508 including a hard disk, and the like; and a communication part 1509 including a network interface card such as a LAN card, modem and the like. The communication part 1509 performs communication processing via a network such as the Internet. A driver 1510 is also connected to the I/O interface 1505 as required. A removable media 1511 such as magnetic disk, optical disk, magnetic-optical disk, semiconductor memory and the like is mounted on the driver 1510 as required so that a computer program read therefrom may be mounted into the storage part 1508 as required.

In particular, according to an embodiment of the present disclosure, the process described below with reference to the flowchart may be implemented as a computer software program. For example, an embodiment of the present disclosure includes a computer program product including a computer program carried on a computer readable medium, and the computer program includes program codes for performing the method illustrated in the flowchart. In such an embodiment, the computer program may be downloaded and installed from a network via the communication part 1509 and/or installed from the removable medium 1511. The computer program, when executed by the central processing unit (CPU) 1501, performs various functions as defined in the system of the present disclosure.

It should be noted that the computer-readable medium shown in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, device, or apparatus, or any combination thereof. More specific examples of computer-readable storage media may include, but are not limited to: electrical connection with one or more wires, portable computer disk, hard disk, random access memory (RAM), read-only memory (ROM), erasable programmable read-only memory (EPROM or flash memory), optical fiber, portable compact disk read-only memory (CD-ROM), optical storage device, magnetic storage device, or any suitable combination thereof. In the present disclosure, the computer-readable storage medium may be any tangible medium that contains or stores a program, and the program may be used by or in combination with an instruction execution system, apparatus, or device. In the present disclosure, the computer-readable signal medium may include a data signal propagated in a baseband or as a part of a carrier wave, in which a computer-readable program code is carried. Such propagated data signal may take many forms, including but not limited to electromagnetic signals, optical signals, or any suitable combination thereof. The computer-readable signal medium may also be any computer-readable medium other than the computer-readable storage medium, and such computer-readable medium can send, propagate, or transmit the program for being used by or in combination with the instruction execution system, apparatus, or device. The program code contained on the computer-readable medium may be transmitted by any suitable medium, including but not limited to: wireless, wire, optical cable, RF or any suitable combination thereof

The flowcharts and block diagrams in the accompanying drawings illustrate possible implementations of the architecture, functionality and operation of systems, methods and computer program products in accordance with various embodiments of the present disclosure. In this regard, each block in a flowchart or block diagram may represent a module, program segment, or a portion of code, and the module, program segment, or portion of code contains one or more executable instructions for implementing a specified logical function. It should also be noted that in some implementations as replacements, the functions indicated in the blocks may also occur in a different order than that indicated in the accompanying drawings. For example, two blocks represented one after the other may actually be executed in substantial parallel, and may sometimes be executed in the opposite order, depending on the function involved. It is also noted that each block in the block diagram or flowchart, and the combination of blocks in the block diagram or flowchart, may be implemented with a dedicated hardware-based system that performs the specified function or operation, or may be implemented with a combination of dedicated hardware and computer instructions.

As another aspect, the present disclosure also provides a computer readable medium which may be contained in the electronic device described in the above embodiments; or may be present separately and not assembled into that electronic device. The computer readable medium carries one or more programs which, when executed by one of the electronic devices, cause the electronic device to implement the method as described in the following embodiments.

It should be noted that although a number of modules in the device for action execution are described in the detailed description above, this division is not mandatory. In fact, according to an embodiment of the present disclosure, the features and functions of two or more modules described above may be specified in a single module. Conversely, the features and functions of one module described above may be further divided to be specified by a plurality of modules.

Those skilled in the art may easily conceive of other embodiments of the present disclosure upon consideration of the specification and practice of the invention disclosed herein. The present disclosure is intended to cover any variation, use or adaptation of the present disclosure that follows the general principle of the present disclosure and includes the common knowledge or customary technical means in the art that are not disclosed herein.

It is to be understood that the present disclosure is not limited to the precise construction already described above and illustrated in the accompanying drawings, and that various modifications and changes may be made without departing from the scope of the present disclosure. The scope of the present disclosure is limited only by the appended claims.

1. A method for determining a queuing scheme, comprising:
obtaining a plurality of candidate queuing schemes by using each of to-be-executed items in turn as a first-order item and using the to-be-executed item other than the first-order item as other items;
for each of the candidate queuing schemes, obtaining a completion time for the first-order item according to a number of current queueing people for the first-order item and a unit execution time for the first-order item;
determining a number of increased queuing people for each of the other items according to the completion time for the first-order item;
obtaining the completion time for all the other items according to the number of the current queuing people, the number of the increased queuing people and a corresponding unit execution time for each of the other items; and
calculating a total time for completion of all the to-be-executed items in each of the candidate queuing schemes, and determining a target queuing scheme according to the total time.

2. The method for determining the queuing scheme according to claim 1, wherein obtaining the completion time for all the other items according to the number of the current queuing people, the number of the increased queuing people and the corresponding unit execution time for each of the other items comprises:
obtaining the completion time for all the other items by performing iteration according to a number of iterations and according to the number of the current queuing people, the number of the increased queuing people and the corresponding unit execution time for each of the other items.

3. The method for determining the queuing scheme according to claim 2, wherein obtaining the completion time for all the other items by performing iteration according to the number of the iterations and according to the number of the current queuing people, the number of the increased queuing people and the corresponding unit execution time for each of the other items comprises:
determining the number of the iterations according to a total number of the to-be-executed items;
a step of determining a next item, comprising, for each of the candidate queuing schemes, determining a current-order item and using an unordered item of the other items in turn as a next-order item;
a step of calculating the completion time, comprising obtaining the completion time for the next-order item according to the number of the current queuing people, the number of the increased queuing people and the corresponding unit execution time for the next-order item;
a step of determining a number of increased people, comprising determining, according to the completion time of a current ordered item, the number of the increased queuing people for each of the unordered item other than the current ordered item in the other items; and
determining the completion time of each order item in turn by repeating, according to the number of the iterations, the step of determining the next item, the step of calculating the completion time and the step of determining the number of the increased people, and obtaining the completion time for all the other items according to the completion time of each order item.

4. The method for determining the queuing scheme according to claim 2, wherein obtaining the completion time for all the other items by performing iteration according to the number of the iterations and according to the number of the current queuing people, the number of the increased queuing people and the corresponding unit execution time for each of the other items comprises:
obtaining a predetermined number of iterations;
a step of determining a next item, comprising, for each of the candidate queuing schemes, determining a current-order item and using an unordered item of the other items in turn as a next-order item;
a step of calculating the completion time, comprising obtaining the completion time for the next-order item according to the number of the current queuing people, the number of the increased queuing people and the corresponding unit execution time for the next-order item;
a step of determining a number of increased people, comprising determining, according to the completion time of a current ordered item, the number of the increased queuing people for each of the unordered item other than the current ordered item in the other items;
determining the completion time for predetermined-order items corresponding to the predetermined number of the iterations in all the other items in turn by repeating, according to the predetermined number of the iterations, the step of determining the next item, the step of calculating the completion time, and the step of determining the number of the increased people; and
after the iteration, obtaining the completion time for all the other items according to the completion time for the predetermined-order items.

5. The method for determining the queuing scheme according to claim 3, wherein obtaining the completion time for the first-order item according to the number of the current queueing people for the first-order item and the unit execution time for the first-order item comprises:
obtaining a movement distance between the first-order item and the next-order item to the first-order item;
obtaining movement speed data of a user, and obtaining a movement time of the user according to a ratio between the movement distance and the movement speed data; and
obtaining the completion time for the first-order item according to the movement time of the user, the number of the current queueing people for the first-order item and the unit execution time for the first-order item.

6. The method for determining the queuing scheme according to claim 3, wherein obtaining the completion time for the next-order item according to the number of the current queuing people, the number of the increased queuing people and the corresponding unit execution time for the next-order item comprises:
obtaining a total number of people executing the next-order item according to the number of the current queuing people and the number of the increased queuing people for the next-order item;
obtaining a waiting time for the next-order item according to the total number of people executing the next-order item and the unit execution time for the next-order item; and
obtaining the completion time for the next-order item according to the waiting time for the next-order item, the completion time for the current-order item and the unit execution time for the next-order item.

7. The method for determining the queuing scheme according to claim 6, wherein obtaining the completion time for the next-order item according to the waiting time for the next-order item, the completion time for the current-order item and the unit execution time for the next-order item comprises:
obtaining the completion time for the next-order item according to the waiting time for the next-order item, the completion time for the current-order item and the unit execution time for the next-order item when a sum of the waiting time for the next-order item and the unit execution time for the next-order item is greater than or equal to the completion time for the current first-order item; and
taking the unit execution time for the next-order item as the completion time for the next-order item when the sum of the waiting time for the next-order item and the unit execution time for the next-order item is smaller than the completion time for the current-order item.

8. The method for determining the queuing scheme according to claim 6, wherein obtaining the completion time for the next-order item according to the waiting time for the next-order item, the completion time for the current-order item and the unit execution time for the next-order item comprises:
determining, from the unordered item, the order item after the next-order item, and obtaining a movement distance between the next-order item and the order item after the next-order item;
obtaining movement speed data of a user, and obtaining a movement time of the user according to a ratio between the movement distance and the movement speed data; and
obtaining the completion time for the next-order item according to the movement time of the user, the waiting time for the next-order item, the completion time for the current-order item and the unit execution time for the next-order item.

9. The method for determining the queuing scheme according to claim 1, wherein determining the number of the increased queuing people for each of the other items according to the completion time for the first-order item comprises:
obtaining historical data of increased users within a plurality of unit time periods, and determining a number of the increased users within the completion time for the first-order item according to the historical data; and
determining the number of the increased queuing people for each of the other items within the completion time for the first-order item according to the number of the increased users within the completion time for the first-order item.

10. The method for determining the queuing scheme according to claim 9, wherein obtaining the historical data of the increased users within the plurality of the unit time periods comprises:
obtaining a collection period for the historical data; and
obtaining the historical data of the increased users within the unit time period of corresponding time points in each collection period according to the collection period for the historical data.

11. The method for determining the queuing scheme according to claim 9, wherein obtaining the historical data of the increased users within the plurality of unit time periods comprises:
randomly obtaining the historical data of the increased users within the plurality of unit time periods.

12. The method for determining the queuing scheme according to claim 9, wherein the historical data of the increased users within the plurality of unit time periods obeys a first probability distribution, and determining the number of the increased users within the completion time for the first-order item according to the historical data comprises:
determining a distribution parameter in the first probability distribution according to the historical data, and determining a number of the unit time periods within the completion time for the first-order item; and
determining the number of the increased users within the completion time for the first-order item according to the distribution parameter and the number of the unit time periods within the completion time for the first-order item.

13. The method for determining the queuing scheme according to claim 12, wherein determining the number of the increased users within the completion time for the first-order item according to the distribution parameter and the number of the unit time periods within the completion time for the first-order item comprises:
determining the number of the increased users within the completion time for the first-order item based on the first probability distribution according to the distribution parameter and the number of the unit time periods, when the unit time periods within the completion time for the first-order item are all integral unit time periods;
determining a second probability distribution obeyed by the incomplete unit time period according to the first probability distribution obeyed by the integral unit time period, when the unit time periods within the completion time for the first-order item comprises the integral unit time period and an incomplete unit time period;
determining a first number of the increased users within the integral unit time period based on the first probability distribution according to the distribution parameter and the number of the integral unit time periods;
determining a second number of the increased users within the incomplete unit time period based on the second probability distribution according to the distribution parameter; and
determining the number of the increased users within the completion time for the first-order item according to the first number of the increased users and the second number of the increased users.

14. The method for determining the queuing scheme according to claim 13, wherein determining the first number of the increased users within the integral unit time period based on the first probability distribution according to the distribution parameter and the number of the integral unit time periods comprises:
determining an expected value of the first number of the increased users based on first probability distribution according to the distribution parameter and the number of the integral unit time periods; and
using the expected value of the first number of the increased users as the first number of the increased users for the integral unit time period within the completion time for the first-order item.

15. The method for determining the queuing scheme according to claim 13, wherein determining the second number of the increased users within the incomplete unit time period based on the second probability distribution according to the distribution parameter comprises:
determining an expected value of the second number of the increased users based on the second probability distribution according to the distribution parameter; and
using the expected value of the second number of the increased users as the second number of the increased users for the incomplete unit time period within the completion time for the first-order item.

16. The method for determining the queuing scheme according to claim 9, wherein determining the number of the increased queuing people for each of the other items within the completion time for the first-order item according to the number of the increased users within the completion time for the first-order item comprises:
obtaining a historical number of the increased queuing people for each of the other items within the plurality of unit time periods according to the historical data of the increased users, wherein the historical number of the increased queuing people obeys a third probability distribution;
determining a distribution parameter in the third probability distribution according to the historical number of the increased queuing people for each of the other items within the plurality of unit time periods; and
determining the number of the increased queuing people for each of the other items within the completion time for the first-order item according to the number of the increased users within the completion time for the first-order item and the distribution parameter in the third probability distribution.

17. The method for determining the queuing scheme according to claim 16, wherein determining the number of the increased queuing people for each of the other items within the completion time for the first-order item according to the number of the increased users within the completion time for the first-order item and the distribution parameter in the third probability distribution comprises:
determining an expected value of the number of the increased queuing people for each of the other items according to the number of the increased users within the completion time for the first-order item and the distribution parameter in the third probability distribution; and
using the expected value of the number of the increased queuing people as the number of the increased queuing people for each of the other items within the completion time for the first-order item.

18. The method for determining the queuing scheme according to claim 1, wherein determining the target queuing scheme according to the total time comprises:
determining the candidate queuing scheme with a least total time as the target queuing scheme.

19. (canceled)

20. An electronic device, comprising:
a processor; and
a memory having one or more programs stored thereon that, when being executed by the one or more processors, cause the one or more processors to implement actions of:
obtaining a plurality of candidate queuing schemes by using each of to-be-executed items in turn as a first-order item and using the to-be-executed item other than the first-order item as other items;
for each of the candidate queuing schemes, obtaining a completion time for the first-order item according to a number of current queueing people for the first-order item and a unit execution time for the first-order item;
determining a number of increased queuing people for each of the other items according to the completion time for the first-order item;
obtaining the completion time for all the other items according to the number of the current queuing people, the number of the increased queuing people and a corresponding unit execution time for each of the other items; and
calculating a total time for completion of all the to-be-executed items in each of the candidate queuing schemes, and determining a target queuing scheme according to the total time.

21. A non-transitory computer readable storage medium having a computer program stored thereon that, when being executed by a processor, causes the processor to implement actions of:
obtaining a plurality of candidate queuing schemes by using each of to-be-executed items in turn as a first-order item and using the to-be-executed item other than the first-order item as other items;
for each of the candidate queuing schemes, obtaining a completion time for the first-order item according to a number of current queueing people for the first-order item and a unit execution time for the first-order item;
determining a number of increased queuing people for each of the other items according to the completion time for the first-order item;
obtaining the completion time for all the other items according to the number of the current queuing people, the number of the increased queuing people and a corresponding unit execution time for each of the other items; and
calculating a total time for completion of all the to-be-executed items in each of the candidate queuing schemes, and determining a target queuing scheme according to the total time.
